(19) United States
(12) Patent Application Publication
(10) Pub. No.: US 2012/0128455 A1
(43) Pub. Date: May 24, 2012

(54) TRANSPORT SYSTEM AND STORAGE DEVICE

(75) Inventors: Tatsuo Tsubaki, Ise-shi (JP); Hideki Kato, Ise-shi (JP)

(73) Assignee: MURATEC AUTOMATION CO., LTD., Kyoto-shi, Kyoto (JP)

(21) Appl. No.: 13/387,275

(22) PCT Filed: Jul. 23, 2010
(86) PCT No.: PCT/JP10/04718

§ 371 Date: Jan. 26, 2012

(30) Foreign Application Priority Data
Jul. 29, 2009 (JP) 2009-176384

(51) Int. Cl. B65G 1/00

(52) U.S. Cl. 414/293; 414/589

(57) ABSTRACT

In a transport system, two drop prevention barriers and a drop prevention mechanism are provided along a periphery of a load port where a transported article has been placed. The drop prevention barriers and the drop prevention mechanism are arranged on three sides around the periphery of the load port and a remaining side is open along a first direction. The drop preventing mechanism includes a retaining member rotatably supported on a bracket. When a transported article moves along the first direction, the retaining member is pushed by a transport device such that it rotates from an initial position and retracts in an opposite direction from where a path is located. When the transported article has been loaded onto the load port, the retaining member returns to the initial position such that it is arranged slightly above the transported article.

### BACKGROUND OF THE INVENTION

1. Field of the Invention

The present invention relates to a transport system including a storage device provided with a load port arranged for an article to be loaded to a prescribed position. The present invention further relates to a storage device of such a transport system.

2. Description of the Related Art

Some transport systems are provided with a storage device serving to temporarily store an article being conveyed during a conveyance process. An overhead buffer described in Japanese Patent Number 4045451 is one example of such a storage device. In Japanese Patent Number 4045451, a drop prevention barrier is provided such that it surrounds the article in order to prevent the article from falling from the overhead buffer.

In the case of the overhead buffer presented in Japanese Patent Number 4045451, a drop prevention barrier is provided such that it surrounds the article. Consequently, when an article is loaded to the inside of the drop prevention barrier and when an article is taken from within the drop prevention barrier to the outside of the overhead buffer, the article must be moved such that it clears the drop prevention barrier. Thus, in order to load an article into the overhead buffer or unload an article from the overhead buffer, the article must be moved vertically across a height that is at least the same as the height of the drop prevention barrier. If the distance through which an article needs to be moved is long, the process of loading and unloading articles may be time-consuming and the efficiency of the entire conveyance process may decline.

### SUMMARY OF THE INVENTION

Preferred embodiments of the present invention provide a transport system in which a distance an article needs to be moved during loading or unloading of the article with respect to a storage device is comparatively short, and also provide a storage device of such a transport system.

A plurality of preferred embodiments of the present invention will now be explained and various features, elements, characteristics, steps, etc. of the preferred embodiments of the present invention can be combined freely as necessary.

A transport system according to a preferred embodiment of the present invention includes a transport device, a storage device, a drop prevention member, and a drop prevention mechanism. The transport device is arranged to move an article in a horizontal direction and a vertical direction. The storage device includes a load port where an article moved by the transport device is loaded to a loading section. The drop prevention member surrounds a portion of the perimeter of the loading section and is open in a region through which an article passes. The drop prevention mechanism is arranged to limit a tilted orientation of the article when the article is arranged on the loading section of the load port and to allow the article to be carried in or carried out when the transport device loads or unloads the article to or from the loading section. The drop prevention mechanism includes a retaining member, a first moving member, and a second moving member. The retaining member is movable between a first position near an upper surface of an article loaded to the loading section and a second position that is removed from above the article loaded to the loading section. The first moving member moves the retaining member from the first position to the second position when the transport device carries the article onto the loading section and when the transport device carries the article out from the loading section. The second moving member moves the retaining member from the second position to the first position after the transport device has loaded an article onto the loading section.

With this transport system, the retaining member prevents an article loaded to the loading section from dropping when the retaining member is positioned in the first position near an upper surface of the article. In this way, it is not necessary for a drop prevention member to surround the article and at least a region around the loading section through which the article passes is open. Thus, when the transport device loads an article to the load port or removes an article from the load port, it is not necessary to raise and lower the article in order to clear a drop prevention member. As a result, a distance through which an article is moved when loading and unloading the article to and from the storage device can be reduced.

When the transport device carries an article in or out, the first moving member moves the retaining member from the first position to the second position such that the retaining member does not obstruct the passage of the article as it moves in or out.

Meanwhile, after the transport device has loaded an article onto the loading section, the second moving member moves the retaining member from the second position to the first position, thus enabling the article to be appropriately prevented from dropping.

The first moving member is preferably realized by arranging the mechanism such that when the transport device carries the article onto the loading section or out from the loading section, the transport device or the article pushes the retaining member to move the retaining member from the first position to the second position. In this way, the retaining member is moved in coordination with the operation of the transport device carrying an article in or out and, thus, the retaining member can be moved in an appropriate fashion.

Also, it is preferable for the drop prevention mechanism to include an axial support member arranged to rotatably support the retaining member and for the retaining member to move between the first position and the second position by rotating about the axial support member. In this way, the retaining member can be moved with a simple structure.

The second moving member is preferably realized by arranging the mechanism such that the axial support member rotatably supports the retaining member such that a rotational axis of the retaining member is slightly tilted with respect to a vertical direction and a torque acting in a direction of moving the retaining member from the second position to the first position is obtained due to gravity. In this way, a simple structure can be obtained in which the retaining member moves toward the first position when, for example, there is no other external force acting on the retaining member.

It is also acceptable if the axial support member rotatably supports the retaining member such that the rotational axis of the retaining member is aligned with a horizontal direction.

Additionally, it is acceptable if the drop preventing mechanism also includes a support member arranged to support the retaining member such that the retaining member can move in the same horizontal direction in which the article is moved by the transport device.

It is acceptable if a force applying member arranged to apply a force against the retaining member in a direction extending from the second position toward the first position is provided as the second moving member. In this way, a simple structure can be obtained in which the retaining member is moved toward the first position by the force applying member when, for example, there is no other external force acting on the retaining member.

It is acceptable if an actuator arranged to move the retaining member from the first position to the second position is provided as the first moving member. In this way, the retaining member can be moved at any desired timing.

The transport device preferably includes a gripping portion arranged to grip an article and a hoist section arranged to raise and lower the gripping section in suspended state. It is acceptable if the first moving member includes at least one of the hoist section and the gripping section. In this way, the retaining member is moved in coordination with the operation of the transport device carrying an article in or out and, thus, the retaining member can be moved in an appropriate fashion.

A storage device according to another preferred embodiment of the present invention includes a load port arranged to allow an article to be loaded to a loading section, a drop prevention member, and a drop prevention mechanism. The load port includes a loading section onto which a transport device loads an article. The drop prevention member surrounds a perimeter of the loading section and is open in a region through which an article passes. The drop prevention mechanism includes a retaining member, a first moving member, and a second moving member. The retaining member can be moved between a first position near an upper surface of an article loaded to the loading section and a second position that is removed from above an article loaded to the loading section. The first moving member moves the retaining member from the first position to the second position when the conveying apparatus carries an article in to the loading section and when the conveying apparatus carries an article out from the loading section. The second moving member moves the retaining member from the second position to the first position after the conveying apparatus has loaded an article onto the loading section.

With this storage device, the retaining member prevents an article loaded to the loading section from dropping when the retaining member is positioned in the first position near an upper surface of the article. In this way, it is not necessary for a drop prevention member to surround the article and at least a region around the loading section through which the article passes is open. Thus, when the conveying apparatus loads an article to the load port or removes an article from the load port, it is not necessary to raise and lower the article in order to clear a drop prevention member. As a result, a distance through which an article is moved when loading and unloading the article to and from the storage apparatus can be reduced.

When the transport device carries an article in or out, the first moving member moves the retaining member from the first position to the second position such that the retaining member does not obstruct the passage of the article in or out.

Meanwhile, after the transport device has loaded an article onto the loading section, the second moving member moves the retaining member from the second position to the first position, thus enabling the article to be appropriately prevented from dropping.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a partial plan view of a transport system according to a preferred embodiment of the present invention.

FIG. 2 is a cross sectional view taken along the section line II-II of FIG. 1.

FIG. 3 is a perspective view of the storage device.

FIG. 4A is a perspective view of the drop prevention mechanism.

FIG. 4B is a plan view of the drop prevention mechanism.

FIG. 5A is a plan view of a storage device when a container has been loaded.

FIG. 5B is a frontal view of a storage device when a container has been loaded.

FIG. 6A is a frontal view of a storage device on which a container is arranged in a tilted state.

FIG. 6B is a frontal view of a storage device on which a container is arranged in a tilted state.

FIG. 7A is a frontal view of a storage device and a transport device depicting states of a container being unloaded from the storage device over time.

FIG. 7B is a frontal view of a storage device and a transport device depicting states of a container being unloaded from the storage device over time.

FIG. 7C is a frontal view of a storage device and a transport device depicting states of a container being unloaded from the storage device over time.

FIG. 7D is a frontal view of a storage device and a transport device depicting states of a container being unloaded from the storage device over time.

FIG. 7E is a frontal view of a storage device and a transport device depicting states of a container being unloaded from the storage device over time.

FIG. 8A is a plan view of a support section according to a first variation of the drop prevention mechanism according to a preferred embodiment of the present invention.

FIG. 8B is a perspective view of an upper portion of the drop prevention mechanism according to the first variation according to a preferred embodiment of the present invention.

FIG. 8C is a perspective view of an upper portion of the drop prevention mechanism according to the first variation according to a preferred embodiment of the present invention.

FIG. 9 is a perspective view of a second variation of the drop prevention mechanism according to a preferred embodiment of the present invention.

FIG. 10 is a perspective view of a third variation of the drop prevention mechanism according to a preferred embodiment of the present invention.

FIG. 11 is a perspective view of a fourth variation of the drop prevention mechanism according to a preferred embodiment of the present invention.

FIG. 12 is a perspective view of a fifth variation of the drop prevention mechanism according to a preferred embodiment of the present invention.

### DETAILED DESCRIPTION OF THE PREFERRED EMBODIMENTS

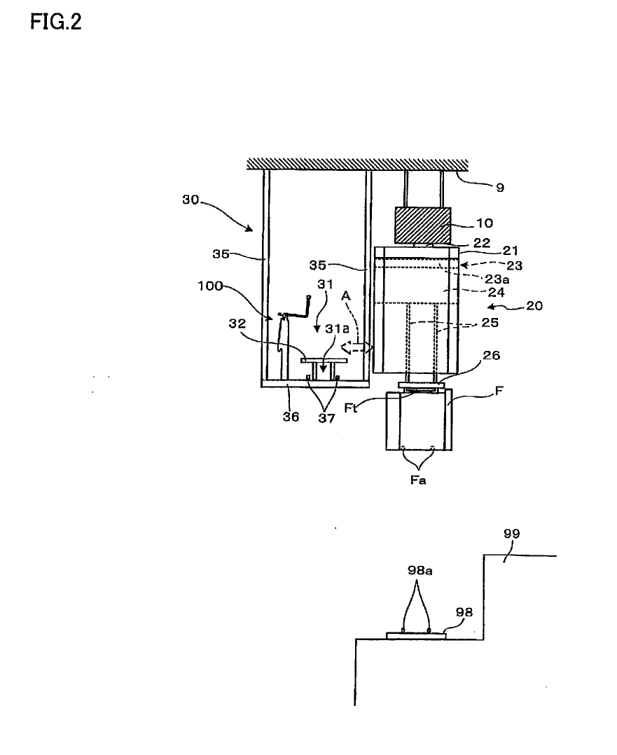

A transport system 1 according to a preferred embodiment of the present invention will now be explained. The transport system 1 is preferably arranged in a factory or other facility to apply various processing treatments to an article. An article to be processed is housed inside a container F (see FIG. 2 and subsequent Figs.) and the container F is an article subjected to conveyance processing by the transport system 1. Processing apparatuses for performing various processing treatments are arranged inside the factory, and the transport system 1 conveys the container F from one processing apparatus to another in order according to a predetermined sequence of processing treatments. For example, if the transport system 1 is installed in a semiconductor substrate manufacturing plant, the processing apparatuses are manufacturing apparatuses arranged to perform various processes for manufacturing semiconductor substrates.

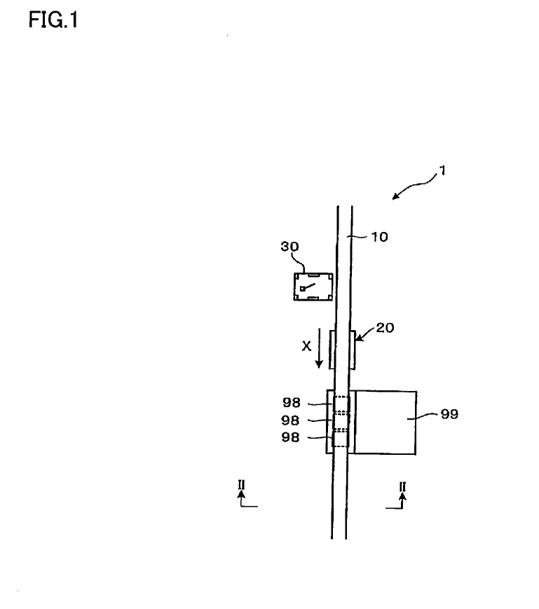

FIG. 1 shows a portion of the transport system 1 installed inside the factory. As shown in FIGS. 1 and 2, the transport system 1 includes a path 10, a transport vehicle 20 (corresponding to the “transport device” according to a preferred embodiment of the present invention) arranged to travel along the path 10, a manufacturing apparatus 99 arranged below the path 10, and a storage device 30 arranged in close proximity to the path 10. The transport vehicle 20 includes a traveling mechanism (not shown) housed inside the path 10 such that the transport vehicle 20 travels along the path 10 in a direction indicated in FIG. 1 while being suspended from the path 10. In this patent specification, all devices and members depicted in FIG. 2 other than the container F are shown in a frontal view. In FIG. 2, a front side of the container F is on the right-hand side and a rear side is on the left-hand side.

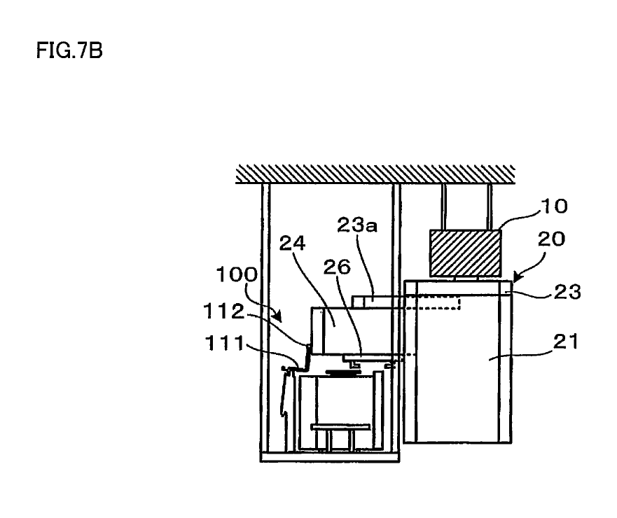

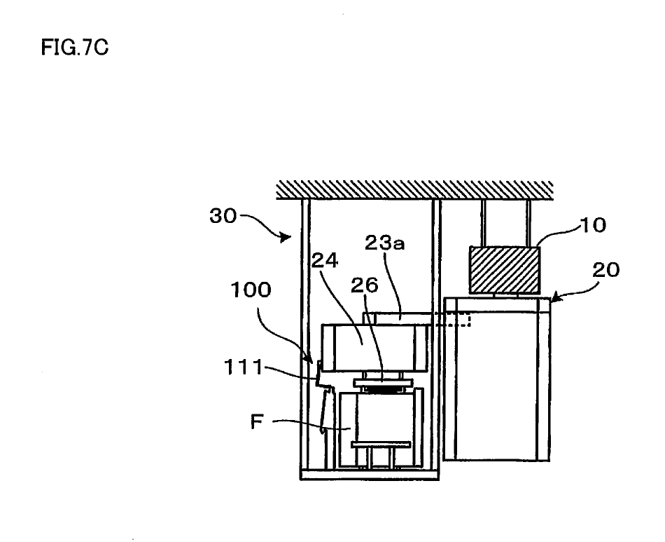

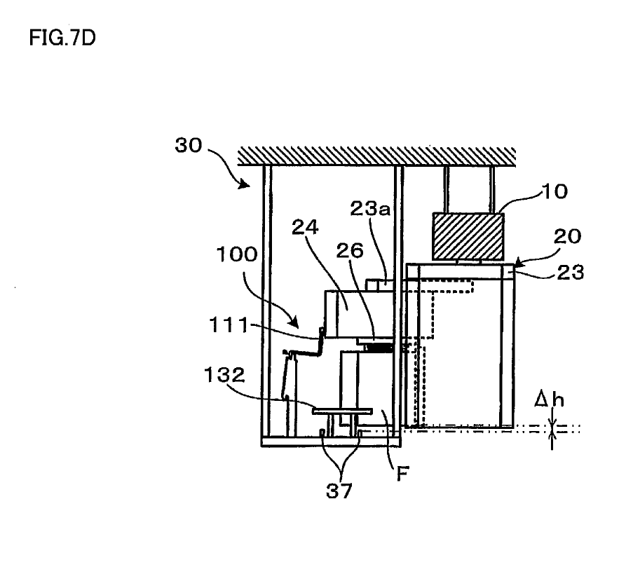

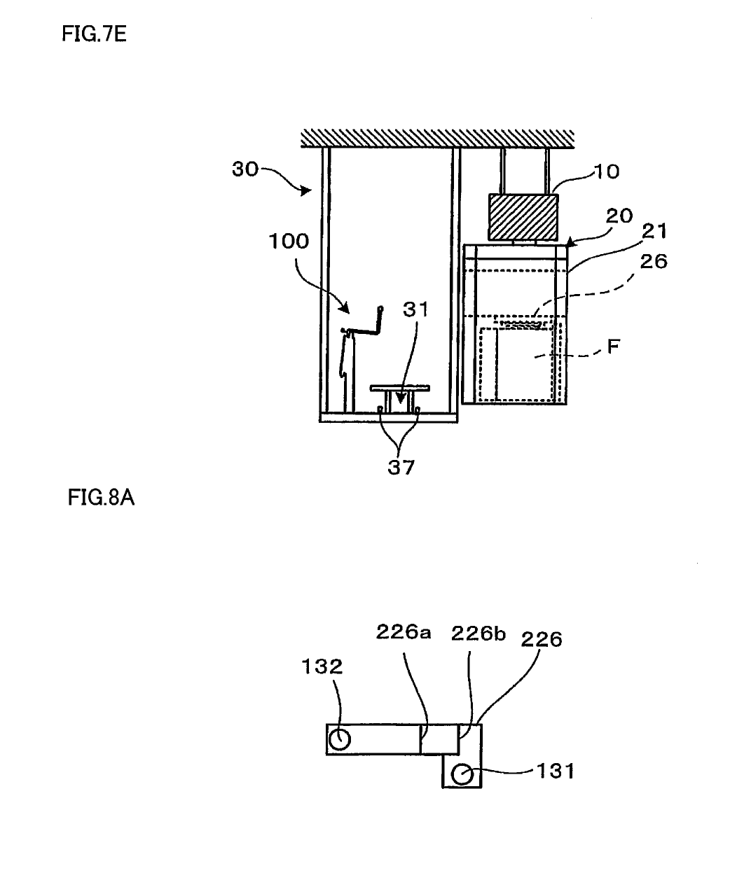

A main body casing 21 is suspended from the traveling mechanism of the transport vehicle 20 through a frame 22. A horizontal movement mechanism 23 is housed inside the main body casing 21. The horizontal movement mechanism 23 includes an arm 23a that suspends a hoist mechanism 24. The arm 23a is arranged to move in a horizontal direction with respect to the main body casing 21, and the horizontal movement mechanism includes a drive member arranged to move the arm 23a in the horizontal direction. The arm 23a can move the hoist mechanism 24 in the horizontal direction. FIGS. 7B to 7D illustrate an example of a state in which the horizontal movement mechanism 23 has moved the arm 23a from the main body casing 21 to the left and, at the same time, the arm 23a has moved the hoist mechanism 24 to the left (to the left of the figure).

As shown in FIG. 2, the hoist mechanism 24 is arranged to suspend a gripping mechanism 26 through a suspension belt 25. The hoist mechanism 24 is provided with a belt winding mechanism arranged to wind in and reel out the suspension belt 25. The gripping mechanism 26 is lowered by reeling out the suspension belt 25 and raised by winding in the suspension belt 25. The gripping mechanism 26 is arranged to grip and release the container F.

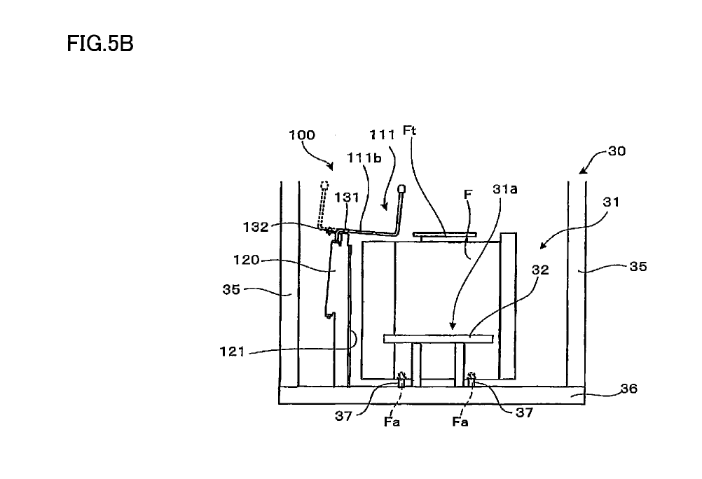

As shown in FIGS. 5A and 5B, the container F has a substantially rectangular shape, and includes an upper panel and a lower panel that are flat and parallel to each other. A flange Ft is provided on the upper panel and protrudes upward. Positioning holes Fa, which regulate the horizontal position of the container F, are provided in the lower panel. The gripping mechanism 26 grips the flange Ft provided on the upper panel of the container F.

As shown in FIG. 2, a load port 98 is provided in the manufacturing apparatus 99 and arranged for the container F to be loaded onto an upper surface thereof. The manufacturing apparatus 99 takes in the container F placed on the load port 98, extracts a semiconductor substrate or another article to be processed from the container F, and performs various processing treatments to the extracted article. A plurality of positioning pins 98a are provided on the upper surface of the load port 98. The positioning pins 98a are members that position the container F in the horizontal direction. The positioning holes Fa are arranged in the bottom panel of the container F such that the positioning pins 98a fit precisely into the positioning holes Fa. The container F is positioned appropriately in the horizontal direction by placing the container F onto the load port 98 such that the positioning pins 98a fit into the positioning holes Fa.

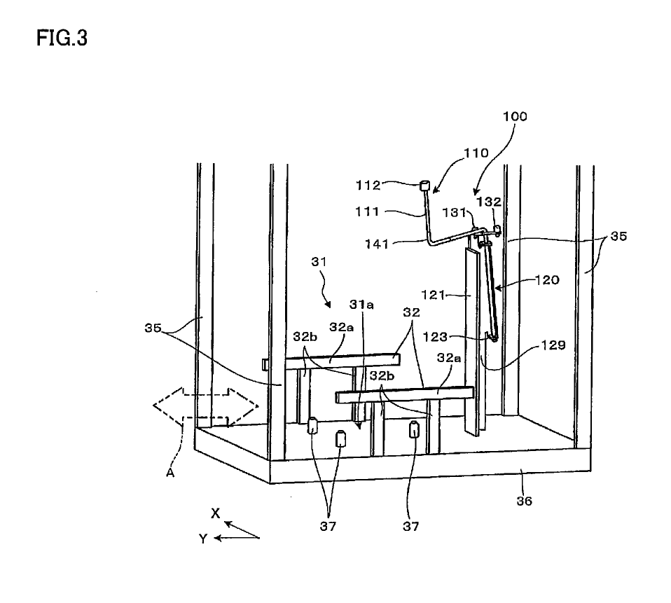

The storage device 30 is a device installed in the transport system 1 to provide a place for the container F to wait for subsequent processes. As shown in FIGS. 2 and 3, the storage device 30 includes a flat, rectangular plate-shaped shelf 36 and, for example, four support pillars 35 to fasten the shelf 36 to a ceiling 9. The support pillars 35 are preferably arranged at four corners of the shelf 36. Each of the support pillars 35 is fixed at an upper end to the ceiling 9 and at a lower end to the shelf 36. The shelf 36 is arranged horizontally.

One load port 31 is provided in the storage device 30 and arranged for the container F to be loaded thereon. It is also acceptable to provide a plurality of load ports. The load port 31 is provided on an upper surface of the shelf 36. Positioning pins 37 corresponding to the positioning holes Fa of the container F are provided on the upper surface of the shelf 36 in a loading section 31a constituting a region corresponding the load port 31.

Two drop prevention barriers 32 and a drop prevention mechanism 100 (which correspond to the “drop prevention mechanism” according to a preferred embodiment of the present invention) are provided along the perimeter of the load port 31 to prevent the container F loaded onto the load port 31 from falling off the shelf 36. The drop prevention mechanism 100 is horizontally arranged on an opposite side of the load port 31 from the path 10. The two drop prevention barriers 32 are arranged such that the load port 31 is arranged therebetween along a longitudinal direction. Each of the drop prevention barriers 32 includes a transverse section 32a that extends in a transverse direction and two support pillars 32b that fix the transverse section 32a to the shelf 36. In this way, the drop prevention mechanism 100 and the two drop prevention barriers 32 are arranged on three sides around the perimeter of the load port 31 and the remaining side is open along the direction of an arrow A shown in FIGS. 2 and 3. Thus, when the container F is moved along the direction of the arrow A, neither the drop prevention mechanism 100 nor the two drop preventing barriers 32 obstructs the movement of the container F.

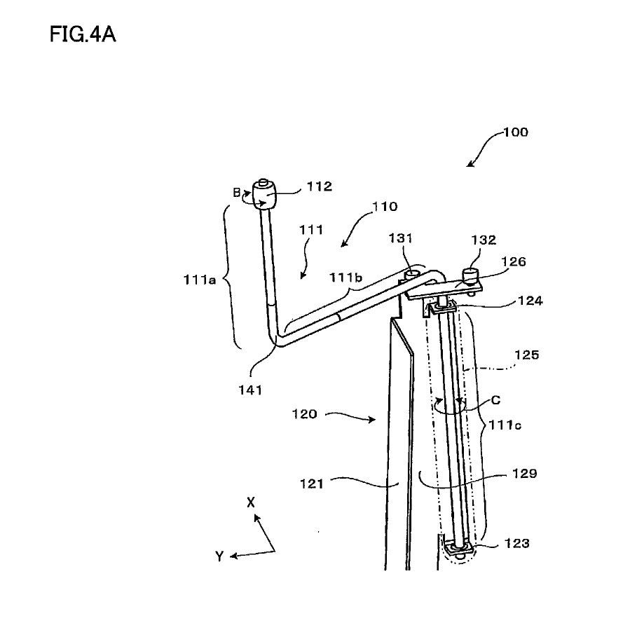

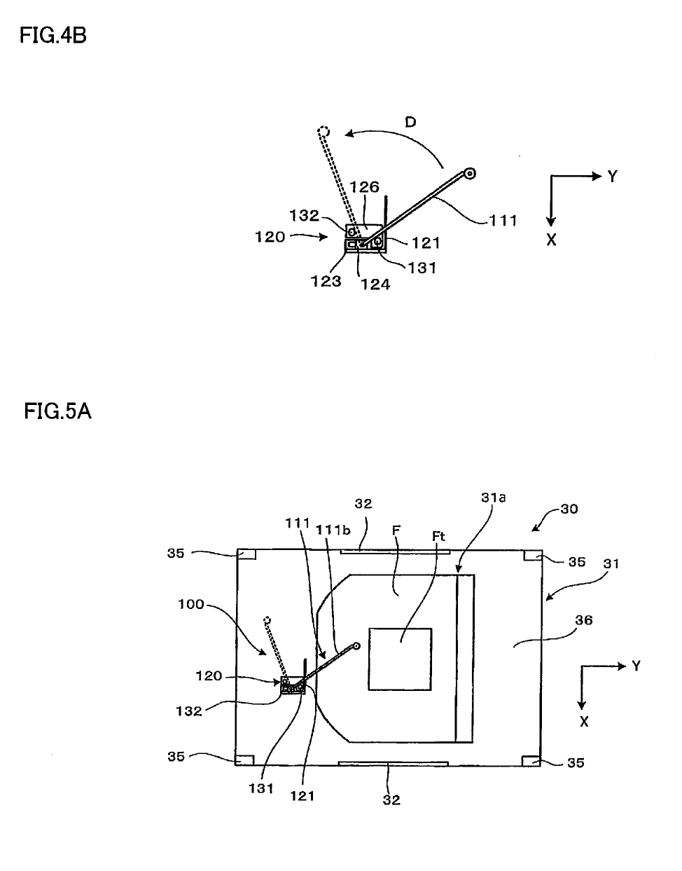

The drop prevention mechanism 100 will now be explained with reference to the FIGS. 3, 4A, and 4B. In each of FIGS. 3, 4A, and 4B, the arrow X indicates a vehicle advancement direction and the arrow Y indicates the direction to the path from the drop preventing mechanism 100. The drop prevention mechanism 100 includes a retaining member 110 and a bracket 120 that supports the retaining member 110. The retaining member 110 includes a crankshaft 111 that is substantially bent into the shape of a crank. The crankshaft 111 includes three sections, i.e., an upper section 111a, a middle section 111b, and a lower section 111c, separated by two bend portions where the crankshaft 111 is substantially bent at right angles. A roller 112 capable of rotating in the direction of arrow B is provided at an upper end portion of the upper section 111a. A tube 141 made of a resin material is arranged to cover the bend portion between the upper section 111a and the middle section 111b.

The various portions of the bracket 120 are formed preferably by bending a metal sheet. More specifically, the bracket 120 includes a main body section 129, a side section 121, a support section 126, and a support section 125. The main body section 129 is arranged to extend along the vertical direction and the left-to-right direction from the perspective of FIG. 3. The side section 121 is bent in a direction opposite the X-direction from an edge of the main body section 129 located on the container F side (path 10 side) of the main body section 129. The support section 126 is connected to an upper end of the main body section 129. The support section 125 is connected to an end of the main body section 129 opposite where the container F is located.

The support section 125 supports the lower section 111c of the crankshaft 111. An upper end and a lower end of the support section 125 are each bent in a direction opposite the X direction so as to form bearings 123 and 124 (corresponding to the “axial support member” according to a preferred embodiment of the present invention) that rotatably support the crankshaft 111. Each of the bearings 123 and 124 is provided with a through hole for the crankshaft 111 to pass through, and the crankshaft 111 is supported in the bearings using retaining rings so that it does not move in an axial direction. The lower bearing 123 is slightly offset in a direction away from the container F from a position directly below the upper bearing 124. As a result, the bearing 123 and the bearing 124 support the crankshaft 111 such that the lower section 111c is tilted slightly toward the container F from a vertical orientation.

The support section 126 is formed preferably by bending an upwardly protruding portion of the main body section 129 in a direction opposite the X direction and, as shown in FIG. 4B, has an L-shaped planar shape arranged to surround the bearing 124 on two sides. An upper surface of the support section 126 lies in a plane perpendicular to the rotational axis of the crankshaft 111. The lower section 111c of the crankshaft 111 protrudes upward from the bearing 124 and bends toward the support section 126 at a position corresponding to the upper surface of the support section 126 so as to connect to the middle section 111b. The middle section 111b rests on the support section 126 and is supported by the upper surface of the support section 126. The position of the support section 126 is adjusted such that, when the middle section 111b is supported on the support section 126, the crankshaft 111 is located at a height slightly above an upper surface of the container F on the load port 31.

Stoppers 131 and 132, which protrude upward, are fixed to the upper surface of the support section 126. As shown in FIG. 4B, the stopper 131 is arranged near an edge portion of the support section 126 that faces in the X direction, and the stopper 132 is arranged near an edge portion of the support section 126 that is farthest from the path 10. The middle section 111b of the crankshaft 111 is arranged in a region between the stoppers 131 and 132.

The crankshaft 111, due to the support by the bracket 120 in this manner, can rotate in the directions C about a rotational axis passing through the bearings 123 and 124. The bearings 123 and 124 support the crankshaft 111 such that the crankshaft 111 is tilted toward the container F. Consequently, gravity results in a torque that tends to rotate the crankshaft 111 toward a position depicted in FIGS. 3, 4A, and 4B, where the upper section 111a and the middle section 111b are lowest (which corresponds to the “first position” according to a preferred embodiment of the present invention). The aforementioned position where the upper section 111a and the middle section 111b are lowest is hereinafter referred to as a “drop prevention position.” The stopper 131 contacts the middle section 111b and limits its movement such that the crankshaft 111 cannot rotate beyond the drop prevention position.

It is acceptable if a magnet is provided in the stopper 131 and the crankshaft 111 is made of a strongly magnetic metal such that the crankshaft 111 is attracted to and held by the stopper 131, for example. In this way, the crankshaft 111 would be less likely to deviate from the drop prevention position due to vibrations caused by an earthquake or the like.

If the crankshaft 111 is rotated against gravity away from the drop prevention position, i.e., in the direction of the arrow D shown in FIG. 4B, the upper section 111a will be elevated until the middle section 111b of the crankshaft 111 hits the stopper 132 at a position indicated in FIG. 4B with a broken line. This position corresponds to a location where the upper section 111a and the middle section 111b are highest and farthest from the drop prevention position and is hereinafter referred to as a “farthest position.” The stopper 132 contacts the middle section 111b such that the crankshaft 111 does not rotate farther from the drop prevention position than the farthest position.

The storage device 30 will now be explained based on a state in which a container F has been loaded onto the load port 31. FIGS. 5A and 5B show the storage device 30 with the container F loaded onto the load port 31. In this state, the container F is sandwiched between the two drop prevention barriers 32 along a longitudinal direction. As a result, the container F is prevented from becoming displaced in a frontward direction or a rearward direction and dropping from the shelf 36. Since the crankshaft 111 is held in the drop prevention position by gravity and the stopper 131, the middle section 111b is located slightly above the upper surface of the container F as shown in FIG. 5. Meanwhile, the side section 121 of the bracket 120 faces toward a back surface of the container F. In this way, the container F is prevented from becoming displaced in a transverse direction and dropping from the shelf 36.

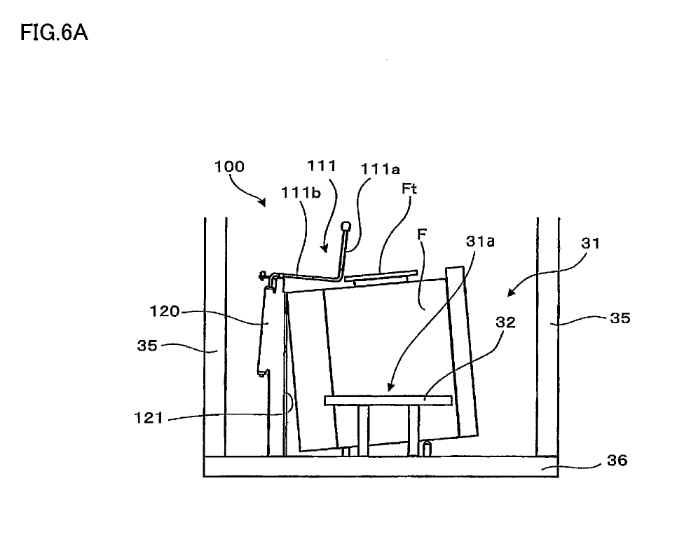

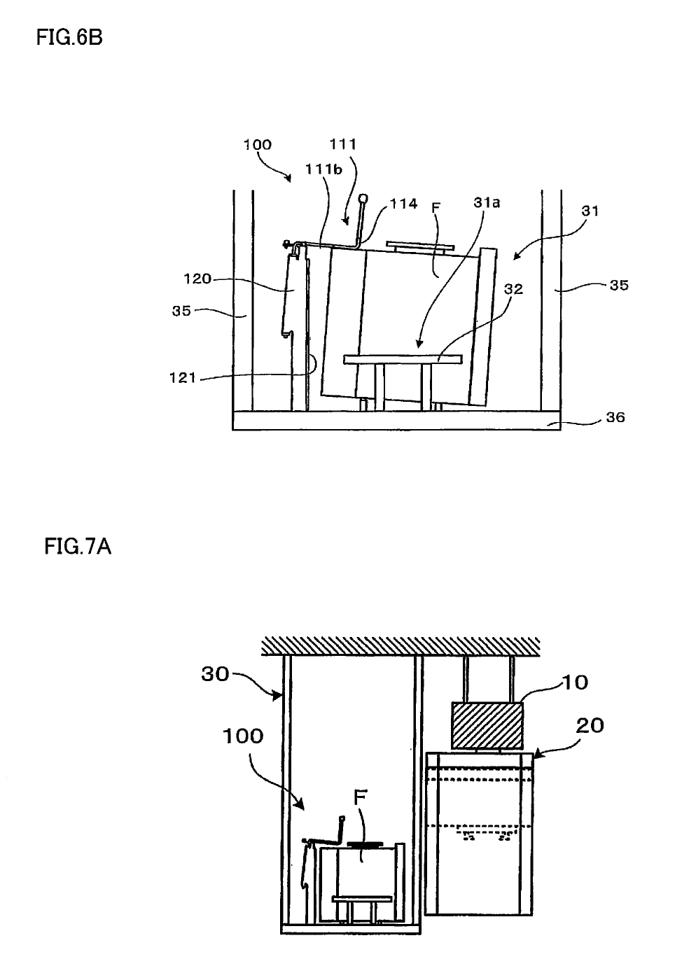

For example, if the container F tilts to the left, then, as shown in FIG. 6A, the back surface of the container F will contact the side section 121 and the container F will be prevented from tilting any further. Alternatively, the container F will be prevented from tilting due to contact between the upper surface or the flange Ft of the container F and the crankshaft 111 near a portion where the crankshaft 111 bends between the upper section 111a and the middle section 111b. If the container F tilts to the right, then, as shown in FIG. 6B, the middle section 111b of the crankshaft 111 will contact the upper surface of the container F and the container F will be prevented from tilting further.

When the container F tilts such that the crankshaft 111 contacts the upper surface of the container F, the tube 141 covering the bend portion of the crankshaft 111 acts to prevent the crankshaft 111 from slipping at where it contacts the upper surface of the container F.

If the crankshaft 111 is rotated from the state indicated by a solid-line in FIGS. 5A and 5B, the crankshaft 111 will retract in a direction opposite to the Y direction (toward the path 10) from a region vertically above the container F and be located in a position indicated with a broken-line in FIGS. 5A and 5B. As a result, the resulting state is one in which the container F can be raised freely in the vertical direction. The position where the crankshaft 111 has been retracted out of a raising/lowering path of the container F is hereinafter referred to as a “retracted position” (and corresponds to the “second position” according to a preferred embodiment of the present invention). Any position from the farthest position to a position very close to the container F in the horizontal direction corresponds to the retracted position.

A series of operations in which the transport vehicle 20 unloads a container F from the load port 31 will now be explained. As shown in FIG. 7A, a container F is loaded in the storage device 30 and the crankshaft 111 of the drop prevention mechanism 100 is held in the drop prevention position. The transport vehicle 20 travels along the path 10 and stops at a position adjacent to the storage device 30.

As shown in FIG. 7B, the horizontal movement mechanism 23 moves the arm 23a toward the storage device 30 and, at the same time, the arm 23a moves the hoist mechanism 24 toward the storage device 30. When the hoist mechanism 24 has moved to a certain degree, a side surface of the hoist mechanism 24 contacts the roller 112 at the upper end of the crankshaft 111. As the hoist mechanism 24 moves further, it pushes the crankshaft 111 and causes the crankshaft 111 to rotate. The hoist mechanism 24 moves until the gripping mechanism 26 is located directly above the flange Ft of the container F. Meanwhile, the crankshaft 111 moves to the aforementioned retracted position.

If the roller 112 were not arranged such that it can rotate, then the surface of the roller 112 would have slid along the surface of the hoist mechanism 24 as the crankshaft 111 rotated, and an excess load could develop between the hoist mechanism 24 and the roller 112 due to the friction force. With this preferred embodiment, however, when the hoist mechanism 24 pushes the roller 112, the roller 112 rotates while the crankshaft 111 moves as a whole. As a result, an excess load caused by friction can be prevented.

The hoist mechanism 24 then lowers the gripping mechanism 26 to a position where the gripping mechanism 26 can grip the container F, and the gripping mechanism 26 grips the container F as shown in FIG. 7C. The hoist mechanism 24 then raises the gripping mechanism 26 to a height (height shown in FIG. 7D) where the positioning pins 37 separate from the positioning holes Fa of the container F. When this occurs, the crankshaft 111 does not obstruct the raising movement of the container F because the crankshaft 111 is in the retracted position shown in FIG. 7C.

Next, as shown in FIG. 7D, the horizontal movement mechanism 23 moves the arm 23a in the Y direction (toward the path 10) and, at the same time, the arm 23a moves the hoist mechanism 24 in the Y direction (toward the path 10). Since a drop prevention member is not located in the movement path of the container F at this time, the movement of the container F is not obstructed. As the hoist mechanism 24 moves, the crankshaft 111 moves from the retracted position toward the drop prevention position due to gravity. When the arm 23a and the hoist mechanism 24 are completely housed inside the main body casing 21 as shown in FIG. 7E, the gripping mechanism 26 and the container F are also housed inside the main body casing 21, and the transport vehicle 20 can move along the path 10 to a subsequent destination.

While the sequence of operations executed when the transport vehicle 20 unloads a container F from the storage device 30 is preferably as explained above, the same operations are executed in the reverse order when the transport vehicle 20 loads a container F into the storage device 30. During loading, too, when the hoist mechanism 24 moves to a position above the load port 31 while holding a container F in a suspended state, the hoist mechanism 24 pushes the crankshaft 111 from the drop prevention position to the retracted position such that the crankshaft 111 does not obstruct the subsequent operations of lowering the container F. After the container F has been placed onto the load port 31, the hoist mechanism 24 is retracted toward the path 10 and the crankshaft 111 rotates to the drop prevention position due to gravity. As a result, the container F can be appropriately prevented from falling off after it has been placed on the load port 31.

The transport system 1 preferably includes a transport vehicle 20, a storage device 30, a drop prevention barrier 32, and a drop prevention mechanism 100. The transport vehicle 20 is arranged to move an article in a horizontal direction and a vertical direction. The storage device 30 includes a load port 31 where an article moved by the transport vehicle 20 is loaded to a loading section 31a. The drop prevention barrier 32 surrounds a portion of the perimeter of the loading section while being open in a region through which an article passes. The drop prevention mechanism 100 is arranged to limit a tilted orientation of the article when the article is arranged on the loading section 31a of the load port 31 and to allow the article to be carried in or carried out to or from the loading section 31a when the transport vehicle 20 loads or unloads the article.

The drop prevention mechanism 100 includes a retaining member 110, a first moving member, and a second moving member. The retaining member 110 can be moved between a first position near an upper surface of the article loaded onto the loading section 31a and a second position that is removed from above the article loaded onto the loading section 31a. The first moving member moves the retaining member 110 from the first position to the second position when the transport vehicle 20 carries an article into the loading section 31a and when the transport vehicle 20 carries an article out from the loading section 31a. The second moving member moves the retaining member 110 from the second position to the first position after the transport vehicle 20 has loaded an article onto the loading section 31a.

With this transport system 1, the retaining member 110 prevents an article loaded onto the loading section 31a from falling when the retaining member 110 is positioned in the first position near the upper surface of the article. In this way, it is not necessary for the drop prevention barriers 32 to surround the article, and at least a region around the loading section 31a through which the article passes is open. Thus, when the transport vehicle 20 loads an article to the load port 31 or removes an article from the load port 31, it is not necessary to raise and lower the article in order to clear the drop prevention barriers 32. As a result, a distance through which an article is moved can be reduced when loading and unloading the article to and from the storage device 30.

When the transport vehicle 20 carries an article in or out, the first moving member moves the retaining member 110 from the first position to the second position, such that the retaining member 110 does not obstruct the passage of the article as it moves in or out.

Meanwhile, after the transport vehicle 20 has loaded an article onto the loading section 31a, the second moving member moves the retaining member 110 from the second position to the first position, thus enabling the article to be appropriately prevented from falling.

The first moving member is arranged such that the transport vehicle 20 or the article pushes and moves the retaining member 110 from the first position to the second position when the transport vehicle 20 carries an article onto the loading section 31a and when the transport vehicle 20 carries an article out from the loading section 31a. In this way, the retaining member 110 is moved in coordination with the operation of the transport vehicle 20 carrying an article in or out. Thus, the retaining member 110 can be moved in an appropriate manner.

In the preferred embodiment of the present invention described above, instead of providing a drop prevention member that surrounds the perimeter of the load port 31, two drop prevention barriers 32 and one drop prevention mechanism 100 preferably are arranged on three sides around the perimeter of the load port 31. Thus, a container F can be carried in and out by a transport vehicle 20 via the remaining side, which is open. Consequently, the container F can be moved between the storage device 30 and the path 10 in a horizontal direction so long as the container F is raised to such a height at which a bottom surface of the container F is higher than the positioning pins 37. In other words, the distance from the bottom surface of the container F to an upper end of the positioning pins 37 (distance Δh in FIG. 7D) can be minimized when the container F is moved in the horizontal direction. Thus, the distance through which the container F needs to be moved during loading and unloading can be minimized, and the amount of time required for loading and unloading can be shortened.

Since the distance from the bottom surface of the container F to the upper end of the positioning pins 37 can be reduced when moving the container F in a horizontal direction, the positioning pins 37 can be arranged in a higher position. Thus, the shelf 36 can be arranged in a higher position and the total height of the storage device 30 can be reduced. As a result, the storage device 30 according to this preferred embodiment can be installed in a factory or other facility where there is not an abundance of space near the ceiling, so as to save space in an upper portion of the factory.

Variations of the drop prevention mechanism according to preferred embodiments of the present invention will now be explained. Many constituent features of the variations are the same as those of the above-described preferred embodiment. Portions of the variations that are the same as those of the above preferred embodiment are indicated with the same reference numerals and explanations thereof are omitted.

### First Variation

In this variation, the shape of the support section is different from that in the previously explained preferred embodiment.

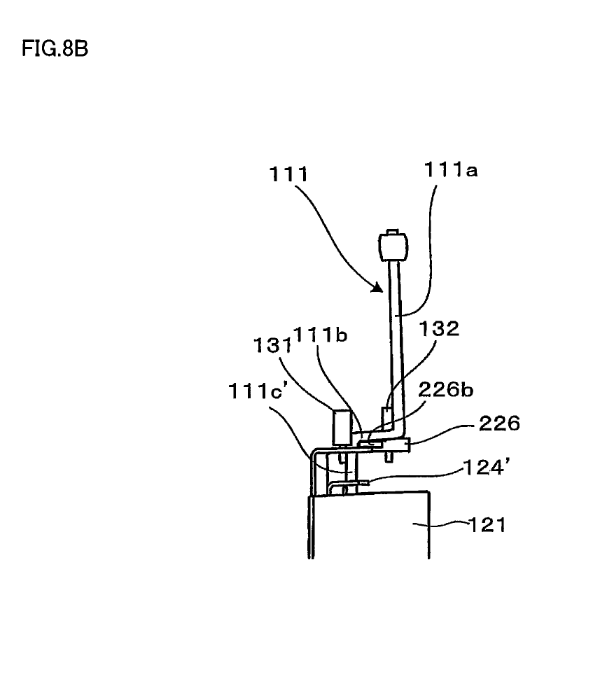

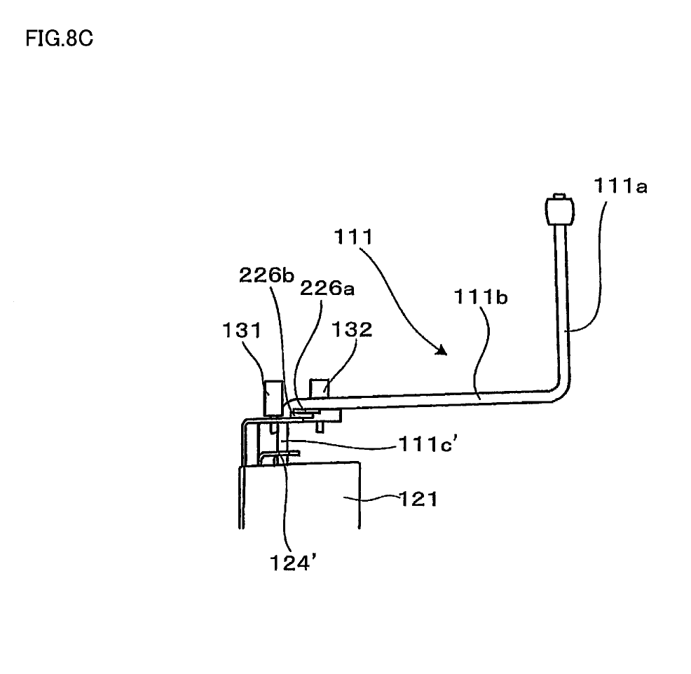

Thus, the first variation is provided with a support section 226 instead of the support section 126 of the previously explained preferred embodiment. As shown in FIG. 8A, two step-shaped portions 226a and 226b are provided on an upper surface of the support section 226, and the step-shaped portions 226a and 226b are arranged such that portions of the upper surface of the support section 226 located farther from the stopper 132 are positioned lower than portions closer to the stopper 132. The lower section 111c of the crankshaft 111 and bearings 124′ and 123′ (not shown) are arranged such that the entire crankshaft 111 can move slightly up and down along the direction of a rotational axis. As a result, the middle section 111b is positioned lowest when the crankshaft 111 is in the drop prevention position (position depicted in FIG. 8B) where it contacts the stopper 131. The middle section 111b moves upward as the crankshaft 111 rotates toward the farthest position (position depicted in FIG. 8C) where it contacts the stopper 132. The step-shaped portions 226a and 226b make it more difficult for the crankshaft 111 to move away from the drop prevention position and easier for the crankshaft 111 to be held in the drop prevention position.

### Second Variation

In this variation, the rotational axis that is vertically extending is not tilted. Also, a force applying member is provided to apply a force against the retaining member in a direction of urging the retaining member from the second position toward the first position.

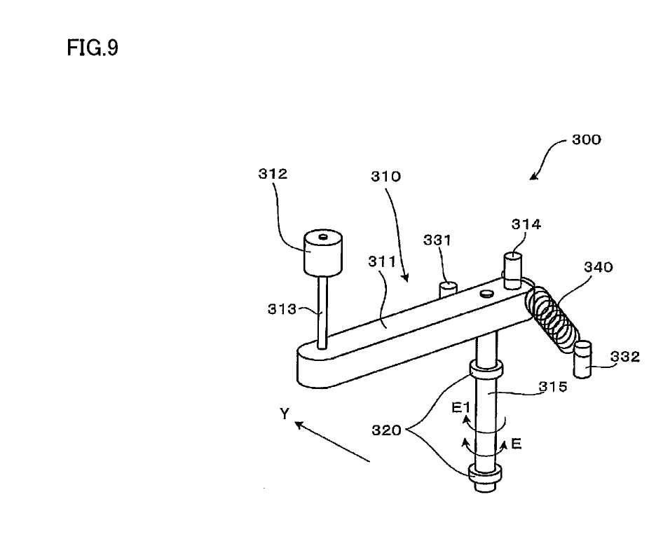

Moreover, a drop prevention mechanism 300 according to the second variation is preferably used instead of the previously explained drop prevention mechanism 100. As shown in FIG. 9, the drop prevention mechanism 300 includes a retaining member 310 and bearings 320 rotatably supporting the retaining member 310. The retaining member 310 includes a horizontal arm 311. A downwardly extending shaft member 315 is fixed to a bottom surface of the horizontal arm 311 in a position near an end portion of the arm. The shaft member 315 is supported on the bearings 320 such that it can rotate in the E directions. The bearings 320 are fixed to a housing of the storage device 30.

An upwardly protruding spring post 314 is provided on an upper surface of the horizontal arm 311 at a position closer to one end of the arm than the shaft member 315. A spring post 332 is fixed to the housing of the storage device 30 at a position separated from the spring post 314 along a direction opposite the Y direction (toward the path 10). A helical spring 340 is attached between the spring posts 314 and 332. The helical spring 340 applies a spring force against the retaining member 310 in a direction of rotating the retaining member 310 in an E1 direction. A stopper 331 is fixed to the housing of the storage device 30 on an opposite side of the horizontal arm 311 from the post 332. The stopper 331 contacts a side surface of the horizontal arm 311 that faces in the Y direction and prevents the horizontal arm 311 from rotating any further. The position where the horizontal arm 311 contacts the stopper 331 is the drop prevention position in this variation.

An upwardly extending support pillar 313 is provided on the upper surface of the horizontal arm 311 near an end portion opposite the end where the post 314 is provided. A roller 312 is provided at an upper end of the support pillar 313. The hoist mechanism 24 contacts the roller 312 when it loads or unloads a container F.

In this variation, when the transport vehicle 20 loads or unloads a container F between the path 10 and the storage 30, the hoist mechanism 24 pushes and rotates the retaining member 310 in a direction opposite the direction E1 such that the retaining member 310 moves to a retracted position. In this way, since the retaining member 310 retracts away from a path through which the container F is lowered and raised, the retaining member 310 does not obstruct a lowering or raising movement of the container F. After the container F has been placed onto the load port 31, the helical spring 340 rotates the retaining member 310 in the E1 direction to the drop prevention position. As a result, the container F is appropriately prevented from falling. It is acceptable to use any other force applying member instead of a helical spring 340. It is also acceptable to incorporate the idea of using a force applying member that applies a force against the retaining member into the previously explained preferred embodiment or the other variations.

### Third Variation

In this variation, the support member supports the retaining member such that the retaining member can move in a horizontal direction in which the transport device moves an article. Also, a force applying member is provided to apply a force against the retaining member in a direction of urging the retaining member from the second position toward the first position.

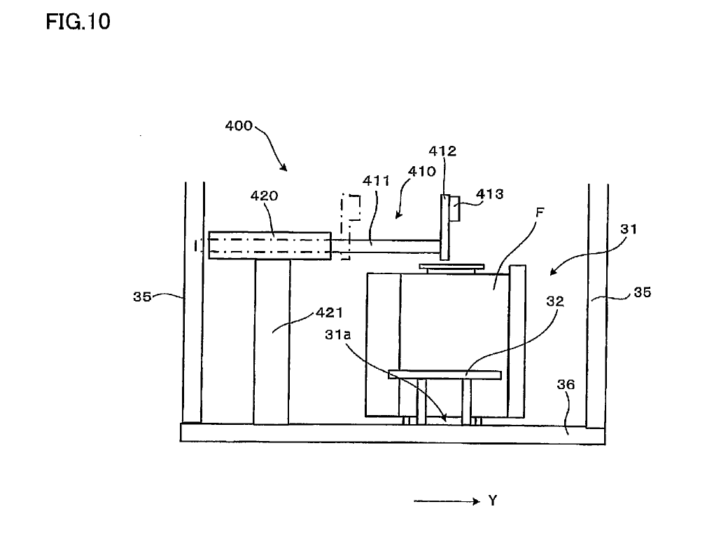

Moreover, a drop prevention mechanism 400 according to the third variation is used instead of the previously explained drop prevention mechanism 100. As shown in FIG. 10, the drop prevention mechanism 400 includes a retaining member 410, a support member 420 that supports the retaining member 410 such that the retaining member 410 can slide towards left and right from the perspective of FIG. 10, and a support pillar 421 that serves to fix the support member 420 above the shelf 36. The retaining member 410 includes a horizontal arm 411 and a pushing plate 412 fixed to an end of the horizontal arm 411 that is oriented toward the Y direction. The pushing plate 412 is a flat plate-shaped member that extends in the vertical direction and a widthwise direction of a container F, and an elastic member 413 is fixed to the surface of the pushing plate 412 that faces in the Y direction. A side surface of the hoist mechanism 24 contacts the elastic member 413 from the right side of FIG. 10. The elastic member 413 functions to absorb an impact that occurs when the hoist mechanism 24 hits it.

A through hole is provided in the support member 420 for the horizontal arm 411 to pass through. A linear guide, bearings, and other guide members to move the horizontal arm 411 towards left and right (from the perspective of FIG. 10) are provided inside the through hole. Also provided inside the support member 420 are a force applying member, e.g., a spring or a magnet, to apply a force against the horizontal arm 411 towards the right (i.e., the right of FIG. 10) and a limiting section arranged to prevent the horizontal arm 411 from moving to the right beyond a position indicated with a solid-line in FIG. 10. The retaining member 410 can move between a drop prevention position (position indicated with a solid-line in FIG. 10) where it is slightly above an upper surface of the container F and a retracted position (position indicated with a broken-line in FIG. 10) where it is to the left of a region vertically above the container F. When the retaining member 410 is not receiving an external force from another device, it is held in the drop prevention position because it is forced towards the right by the force applying member inside the support member 420.

In this variation, when the transport vehicle 20 loads or unloads a container F between the path 10 and the storage 30, the hoist mechanism 24 contacts and pushes the retaining member 410 from the right side of FIG. 10. Since the retaining member 410 can move in the same horizontal directions as the hoist mechanism 24, i.e., the left and right directions in the figure, the retaining member 410 moves to the left (the left of FIG. 10) to the retracted position. In this way, since the retaining member 410 retracts away from a path through which the container F is lowered and raised, the retaining member 410 does not obstruct a lowering or raising movement of the container F. After the container F is loaded onto the load port 31, the force applying member inside the support member 420 moves the retaining member 410 to the drop prevention position. As a result, the container F is appropriately prevented from falling.

### Fourth Variation

In this variation, the retaining member can rotate about a rotational axis aligned with a horizontal direction. Also, a force applying member is provided to apply a force against the retaining member in a direction of urging the retaining member from the second position toward the first position.

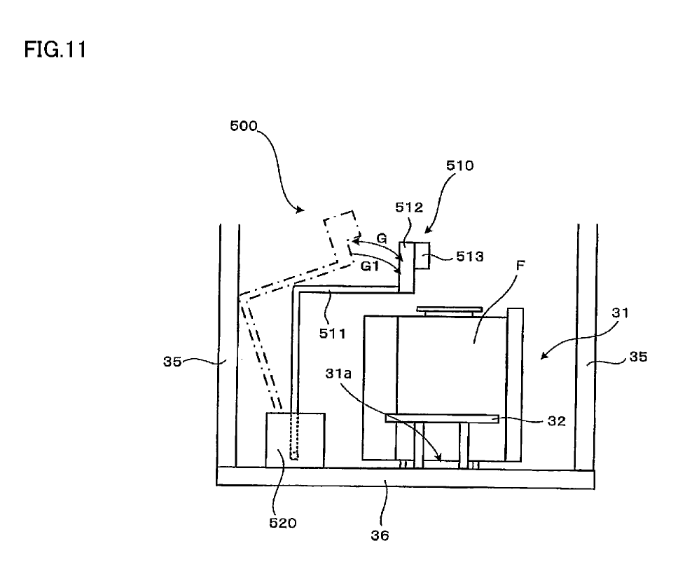

Moreover, as shown in FIG. 11, a drop prevention mechanism 500 according to the fourth variation is preferably used instead of the previously explained drop prevention mechanism 100. The drop prevention mechanism 500 includes a retaining member 510 and a support member 520 arranged to support the retaining member 510 such that the retaining member 510 can rotate in the directions G indicated in FIG. 11. The retaining member 510 includes an L-shaped arm 511 and a pushing plate 512 fixed to an end of the arm 511 that is oriented toward the Y direction. The pushing plate 512 is a flat plate-shaped member that extends in the vertical direction and a widthwise direction of a container F, and an elastic member 513 is fixed to the surface of the pushing plate 512 that faces in the Y direction. A side surface of the hoist mechanism 24 contacts the elastic member 513 from the right side of the figure. The elastic member 513 functions to absorb an impact that occurs when the hoist mechanism 24 hits it.

The support member 520 supports the retaining member 510 such that the retaining member 510 can rotate about a rotational axis oriented in a horizontal direction. Inside the support member 520 are provided a bearing serving to rotatably support the L-shaped arm 511 and a force applying member, e.g., a spring or a magnet, to apply a force against the L-shaped arm 511 in a G1 direction. A limiting section is also provided to prevent the L-shaped arm 511 from moving in the G1 direction beyond a position indicated with a solid-line in FIG. 11. Thus, the retaining member 510 can move between a drop prevention position (position indicated with a solid-line in FIG. 11) where it is slightly above an upper surface of the container F and a retracted position (position indicated with a broken-line in FIG. 11) where it is to the left of a region vertically above the container F. When the retaining member 510 is not receiving an external force from another device, it is held in the drop prevention position because it is forced in the G1 direction by the force applying member inside the support member 520 and gravity.

In this variation, when the transport vehicle 20 loads or unloads a container F between the path 10 and the storage 30, the hoist mechanism 24 pushes and rotates the retaining member 510 in a direction opposite the direction G1 such that the retaining member 510 moves to the retracted position. In this way, since the retaining member 510 retracts away from a path through which the container F is lowered and raised, the retaining member 510 does not obstruct a lowering or raising movement of the container F. After the container F is loaded onto the load port 31, the force applying member inside the support member 520 and gravity move the retaining member 510 to the drop prevention position. As a result, the container F is appropriately prevented from falling.

### Fifth Variation

In this variation, an actuator is provided to move the retaining member from the first position to the second position.

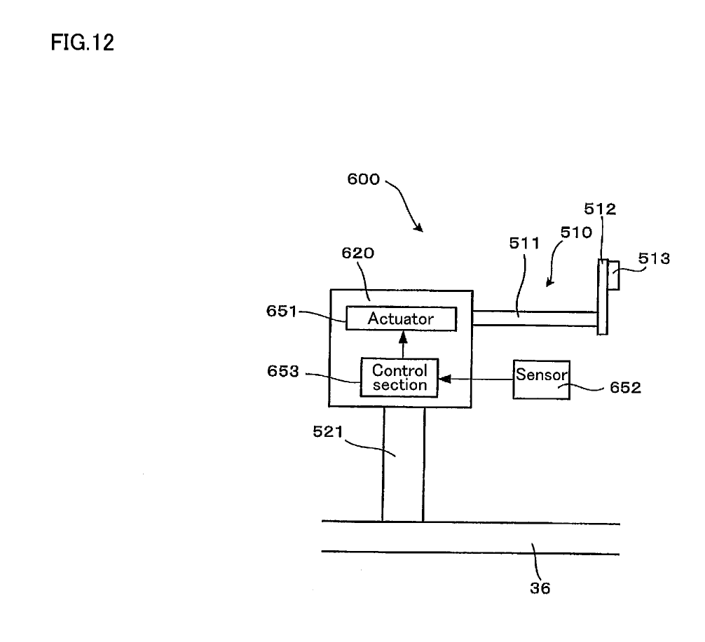

A drop prevention mechanism 600 according to a fifth variation is similar to the drop prevention mechanism according to the fourth variation. As shown in FIG. 12, in this preferred embodiment, a support member 620 is preferably provided instead of the support member 520 of the fourth variation. The support member 620 supports the retaining member 510 such that the retaining member 510 can move in directions corresponding to the left and right directions in the figure. An actuator 651 is provided inside the support member 620 to drive the retaining member 510.

The operation of the actuator 651 is controlled by a control section 653.

A sensor 652 arranged to detect a proximity of the hoist mechanism 24 is provided in the drop prevention mechanism 600. A detection result of the sensor 652 is sent to the control section 653. The control section 653 refers to the detection result of the sensor 652 and determines if the hoist mechanism 24 has drawn close to the retaining member 510. If so, the control section 653 controls the actuator 651 to move the retaining member 510 towards the left of FIG. 12 to a retracted position. Meanwhile, if it determines based on the detection result from the sensor 652 that the hoist mechanism 24 has separated from the retaining member 510, the control section 653 controls the actuator 651 to move the retaining member 510 towards the right of FIG. 12 to the drop prevention position.

In this variation, the actuator 651 moves the retaining member 510 at an appropriate timing such that the retaining member 510 does not obstruct the lowering and raising movements of the container F and the container F can be appropriately prevented from falling after the container F has been loaded. Instead of using a sensor 652, it is acceptable to control the actuator 651 such that it is directly coordinated with the operational control of the transport vehicle 20. For example, the system can be arranged such that the control section 653 receives a signal indicating a movement timing of the hoist mechanism 24 from an operation control section of the transport vehicle 20 and acquires an approach timing of the hoist mechanism 24 based on the signal. It is also acceptable to incorporate the idea of using an actuator to move the retaining member into the previously explained preferred embodiment or the other variations.

### Other Variations

The present invention is not limited to the preferred embodiments explained heretofore. Various changes can be made without departing from the scope of the present invention. In particular, the preferred embodiments and variations presented heretofore can be combined freely as necessary.

For example, although in the previously explained preferred embodiment, a rotatable roller 112 is preferably provided at a tip end of the crankshaft 111, it is acceptable to provide a spherical or cylindrical member that does not roll instead.

In the above preferred embodiment and the variations, the hoist mechanism 24 preferably is arranged to contact and push against the retaining member. However, it is acceptable if the system is arranged such that a portion of the transport vehicle 20 other than the hoist mechanism 24 pushes the retaining member or if a container F gripped by the gripping mechanism 26 contacts the retaining member.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-19. (canceled)

20. A transport system, comprising:
a transport device arranged to move an article in a horizontal direction and a vertical direction;
a load port including a loading section to which the article is loaded by the transport device;
a drop prevention member arranged to prevent an article loaded to the loading section from dropping from the load port and configured to surround a portion of a perimeter of the loading section such that a region through which the article passes is open; and
a drop prevention mechanism arranged to limit a tilted orientation of the article when the article is arranged on the loading section of the load port and to allow the article to be carried in or carried out when the transport device loads or unloads the article to or from the loading section; wherein
the drop prevention mechanism includes:
a retaining member movable between a first position adjacent an upper surface of the article loaded to the loading section and a second position that is removed from above the article loaded to the loading section;
a first moving member arranged to move the retaining member from the first position to the second position when the transport device carries the article onto the loading section and when the transport device carries the article out from the loading section; and
a second moving member arranged to move the retaining member from the second position to the first position after the transport device has loaded the article to the loading section.

21. The transport system recited in claim 20, wherein the first moving member is defined by the transport device or the article pushing the retaining member to move the retaining member from the first position to the second position when the transport device carries the article onto the loading section and when the transport device carries the article out from the loading section.

22. The transport system recited in claim 20, wherein the drop prevention mechanism includes an axial support member that rotatably supports the retaining member, and the retaining member is arranged to move between the first position and the second position by rotating about the axial support member.

23. The transport system recited in claim 21, wherein the drop prevention mechanism includes an axial support member that rotatably supports the retaining member, and the retaining member is arranged to move between the first position and the second position by rotating about the axial support member.

24. The transport system recited in claim 22, wherein the second moving member is defined by the axial support member being arranged to rotatably support the retaining member such that a rotational axis of the retaining member is tilted with respect to a vertical direction and a torque acting in a direction of moving the retaining member from the second position to the first position is obtained due to gravity.

25. The transport system recited in claim 23, wherein the second moving member is defined by the axial support member being arranged to rotatably support the retaining member such that a rotational axis of the retaining member is tilted with respect to a vertical direction and a torque acting in a direction of moving the retaining member from the second position to the first position is obtained due to gravity.

26. The transport system recited in claim 22, wherein the axial support member is arranged to rotatably support the retaining member such that a rotational axis of the retaining member is aligned with a horizontal direction.

27. The transport system recited in claim 23, wherein the axial support member is arranged to rotatably support the retaining member such that a rotational axis of the retaining member is aligned with a horizontal direction.

28. The transport system recited in claim 20, wherein the drop prevention mechanism includes a support member arranged to support the retaining member such that the retaining member can move in a same horizontal direction in which the article is moved by the transport device.

29. The transport system recited in claim 21, wherein the drop prevention mechanism includes a support member arranged to support the retaining member such that the retaining member can move in a same horizontal direction in which the article is moved by the transport device.

30. The transport system recited in claim 20, further comprising a force applying member arranged to apply a force against the retaining member in a direction of moving the retaining member from the second position to the first position as the second moving member.

31. The transport system recited in claim 21, further comprising a force applying member arranged to apply a force against the retaining member in a direction of moving the retaining member from the second position to the first position as the second moving member.

32. The transport system recited in claim 22, further comprising a force applying member arranged to apply a force against the retaining member in a direction of moving the retaining member from the second position to the first position as the second moving member.

33. The transport system recited in claim 23, further comprising a force applying member arranged to apply a force against the retaining member in a direction of moving the retaining member from the second position to the first position as the second moving member.

34. The transport system recited in claim 26, further comprising a force applying member arranged to apply a force against the retaining member in a direction of moving the retaining member from the second position to the first position as the second moving member.

35. The conveyor system recited in claim 27, further comprising a force applying member arranged to apply a force against the retaining member in a direction of moving the retaining member from the second position to the first position as the second moving member.

36. The transport system recited in claim 20, further comprising an actuator arranged to move the retaining member from the first position to the second position as the first moving member.

37. The transport system recited in claim 21, wherein the transport device includes a gripping section arranged to grip the article and a hoist section arranged to raise and lower the gripping section in a suspended state, and the first moving member is defined by at least one of the hoist section and the gripping section.

38. A storage device, comprising:
a load port including a loading section to which an article is loaded by a transport device;
a drop prevention member arranged to surround a portion of a perimeter of the loading section and is open in a region through which the article passes;
a drop prevention mechanism arranged to limit a tilted orientation of the article when the article is arranged on the loading section of the load port and to allow the article to be carried in or carried out when the transport device loads or unloads the article to or from the loading section; wherein
the drop prevention mechanism includes:
a retaining member movable between a first position adjacent an upper surface of the article loaded onto the loading section and a second position that is removed from above the article loaded to the loading section;
a first moving member arranged to move the retaining member from the first position to the second position when the transport device carries the article onto the loading section and when the transport device carries the article out from the loading section; and
a second moving member arranged to move the retaining member from the second position to the first position after the transport device has loaded the article to the loading section.
